(19) United States
(12) Patent Application Publication
(10) Pub. No.: US 2008/0109840 A1
(43) Pub. Date: May 8, 2008

(54) System and method for advertisement skipping

(75) Inventors: Edward Walter, Boerne, TX (US); Steven M. Wollmershauser, San Antonio, TX (US); Yolius Diroo, San Antonio, TX (US); Keith J. Epstein, Califon, NJ (US)

Correspondence Address: SCHWEGMAN, LUNDBERG & WOESSNER, P.A., P.O. BOX 2938, MINNEAPOLIS, MN, 55402, US

(73) Assignee: SBC Knowledge Ventures, L.P.

(21) Appl. No.: 11/594,469

(22) Filed: Nov. 7, 2006

(51) Int. Cl. H04N 7/16

(52) U.S. Cl. 725/25

(57) ABSTRACT

An Internet Protocol Television (IPTV) Set Top Box (STB) provides an option to skip one or more advertisements in an IPTV video broadcast, and receives input from a subscriber relating to the option. The IPTV STB transmits the input to an IPTV server, and then receives back from the IPTV server a payment plan for the IPTV service as a function of the input. The IPTV STB receives additional input regarding the acceptance or rejection of the plan by the subscriber. The payment plan determines the advertisements to be skipped.

### TECHNICAL FIELD

Various embodiments relate to video broadcasts including advertisements, and in an embodiment, but not by way of limitation, to a system and method that provides an option to a broadcast viewer to skip advertisements in a video broadcast.

### BACKGROUND

The commercial video broadcasting of programming to consumers has been around for several decades. It has evolved from its beginnings as simple broadcasts over the airways, to cable and satellite televisions systems, to Internet Protocol (IP) television systems. One common thread among all of these systems is the presence of commercial advertisements, at least as associated with some of the channels available on a television broadcasting medium. While some viewers find the commercial advertisements a pleasant break from the programming, or an additional source of entertainment, other viewers find the advertisements distracting and disruptive. Notwithstanding the disdain of some viewers, broadcasters of programming content derive a good deal of revenue from such advertisements, and are not likely to, and indeed may not be financially able to, relinquish such a revenue stream in the near future without some sort of alternative system.

### BRIEF DESCRIPTION OF THE DRAWINGS

FIG. 1 illustrates an embodiment of a multimedia processing device such as a networked television.

FIG. 2 illustrates a block diagram of an architecture of the networked television of FIG. 1.

FIG. 3 illustrates a block diagram of an embodiment of a multimedia decoder modular card architecture.

FIG. 4 illustrates an example embodiment of a networked television coupled to an Internet Protocol Television (IPTV) server via an Internet Protocol (IP) network.

FIG. 5 illustrates an example embodiment of a Set Top Box (STB).

FIGS. 6, 6A, and 6B illustrate an example embodiment of a process to skip one or more advertisements in connection with a television broadcast service.

FIG. 7 illustrates an example embodiment of a user interface for setting up a service to skip advertisements in a video broadcast.

FIG. 8 illustrates another example embodiment of a process to skip one or more advertisements in connection with a television broadcast service.

FIG. 9 illustrates another example embodiment of a process to skip one or more advertisements in connection with a television broadcast service.

FIG. 10 illustrates a graphical example of a real time content shift of programming content.

FIG. 11 illustrates an embodiment of an architecture that may be used in connection with an IPTV system.

### DETAILED DESCRIPTION

In an embodiment, a method includes configuring an Internet Protocol Television (IPTV) Set Top Box (STB) to display on a display unit an option to skip one or more advertisements in an IPTV video broadcast, receive an input relating to the option, transmit the input relating to the option to an IPTV server, receive from the IPTV server a payment plan, and receive additional input, the additional input indicating an acceptance or a rejection of the payment plan.

In another embodiment, a method includes configuring an Internet Protocol Television (IPTV) server to receive from an IPTV Set Top Box (STB) information relating to an option to skip one or more advertisements in a video broadcast, construct a payment plan for the IPTV STB as a function of the information relating to the option to skip one or more advertisements, transmit the payment plan to the IPTV STB, and receive from the IPTV STB an indication of an acceptance or a rejection of the plan.

In another embodiment, a Set Top Box (STB) includes a processor and a digital video recorder (DVR) coupled to the processor. In this embodiment, the processor is configured to display on a display unit an option to skip one or more advertisements in an IPTV video broadcast, receive an input relating to the option, transmit the input relating to the option to an IPTV server, receive from the IPTV server a payment plan, and receive additional input, the additional input indicating an acceptance or a rejection of the payment plan.

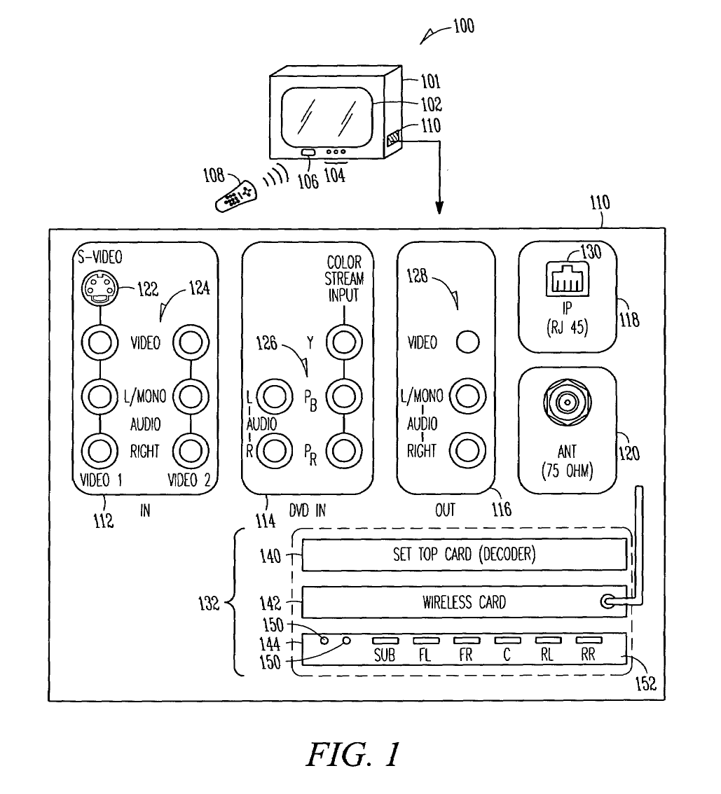

Referring to FIG. 1, an example embodiment of a multimedia processing device such as a networked television 100 is illustrated in accordance with at least one embodiment of the present disclosure. As depicted, the television 100 includes a housing 101 that contains a display 102 (e.g., a liquid crystal display or a plasma display). Further, the housing 101 includes a plurality of user interface buttons 104, such as a power button, channel change buttons, volume control buttons, and the like. The housing 101 also includes a remote control interface 106, for example an infrared interface or a radio frequency (RF) interface, to receive remote control commands from a remote control 108. In a particular embodiment, one or more operations of the television 100 are responsive to the remote control commands. The television 100 further includes an interface panel 110 that is accessible via an external surface of the housing 101, for example at a top, back or side surface of the housing 101. The interface panel 110 includes one or more interfaces for receiving or outputting various forms of multimedia data. As shown, the interface panel 110 includes an IN component 112 that includes, for example, an S-video receptacle 122 and audio-visual receptacles 124, and a digital versatile disk (DVD) IN component 114 that is configured to receive video data and audio data from an external DVD player or other multimedia source. In particular, the DVD IN component 114 includes a plurality of receptacles 126 that can receive component video and audio. The panel 110 also can include an OUT component 116 that has receptacles 128 to provide video data and/or audio data to another television or recording device, such as a personal video recorder (PVR) or an external DVD player/recorder. An RF antenna receptacle 120 also can be incorporated into the panel 110 to receive multimedia data via RF transmissions.

In at least one embodiment, the panel 110 further includes a network interface 118 that includes a network receptacle 130 that can be connected to any of a variety of packet-based data networks. The receptacle 130 can be connected to an Internet Protocol (IP)-based network, for example an Ethernet network or an asynchronous transfer mode (ATM)-based network. Further, in a particular embodiment, the network interface 118 can include an Ethernet interface, and as such, the network receptacle 130 can be an RJ-45 receptacle that is configured to receive an Ethernet cable that is connected to an Ethernet-based network. The television 100 can utilize the network interface 118 to receive multimedia data, for example video data, audio data, or video game data, over a packet-based network for processing at the television 100. Moreover, the network interface 118 may be used by the television 100 to forward information to another networked device, such as another networked television 100. The forwarded information may include, for example, processed multimedia data or information associated with the multimedia data, information associated with a video game being played at the television 100, and the like.

As illustrated in FIG. 1, the panel 110 further can include one or more modular card receptacles 132 (also commonly referred to as “expansion slots”) to interface with one or more modular cards (also commonly referred to as “expansion cards”) to enhance the functionality of the television 100. The modular cards can include, for example, a multimedia decoder modular card 140, a wireless network interface modular card 142, an audio receiver modular card 144, and the like. In a particular embodiment, the modular card receptacles 132 and the corresponding modular cards 140, 142, and 144, may be implemented using a standard architecture, such as a Peripheral Component Interconnect (PCI)-compliant architecture, an Industry Standard Architecture (ISA)-compliant architecture, or a Personal Computer Memory Card International Association (PCMCIA)-compliant architecture. Alternatively, the modular card receptacles 132 and the corresponding modular cards 140, 142, and 144 may be implemented using a proprietary architecture, or a combination of standard and proprietary architectures.

To customize the functionality of the television 100, modular cards may be added or removed from the television by inserting or removing the modular cards from their corresponding modular card receptacles. For example, the panel 110 may include an opening in the housing for each modular card receptacle 132 and each modular card receptacle 132 may receive a modular card that is inserted through the corresponding opening so that the contacts of the modular card receptacle interface are brought into secure contact with the contacts of the receiving modular card receptacle 132. Alternatively, part or all of the panel 110 can be temporarily removed to install the modular card in a modular card receptacle 132. In at least one embodiment, some or all of the modular cards may include one or more interface receptacles that are accessible at the panel 110 to interface with other components.

In a particular embodiment, the incorporation of one or more modular cards into the television 100 allows for an expansion of the available functionality of the television 100. For example, the television 100 may incorporate the wireless network interface modular card 142 to provide wireless connectivity for the transmission of information to other networked devices. Moreover, the television 100 may incorporate the multimedia decoder modular card 140 to process multimedia data. The processing performed by the multimedia decoder modular card 140 may include, for example, decoding or transcoding encoded multimedia data, encoding non-coded multimedia data, decrypting encrypted multimedia data, and the like.

In an embodiment, the multimedia data processed by the decoder modular card 140 may be obtained from an external multimedia device, such as a DVD player, via the interfaces 122-128. Alternatively, the multimedia data may be received as a multimedia data stream via the network interface 118 or via the wireless interface modular card 142. The video content of the resulting processed multimedia data may be displayed on the display 102 or the resulting processed multimedia data may be provided to one or more networked devices via the network interface 118 or the wireless network interface modular card 142.

The television 100 can also incorporate the audio receiver modular card 144 to process audio data for output to one or more speakers. In one embodiment, the audio receiver modular card 144 provides many of the features commonly found in separate stereo receivers. The audio data may be received from an external audio device, e.g., a portable music player, via one or more audio inputs 150. Alternatively, the audio data may be received via the network interface 118 or the wireless network interface modular card 142. The resulting processed audio data may be provided to one or more wired speakers via speaker outputs 152 or the resulting processed audio data may be provided to one or more wireless speakers via, for example, the wireless network interface modular card 142.

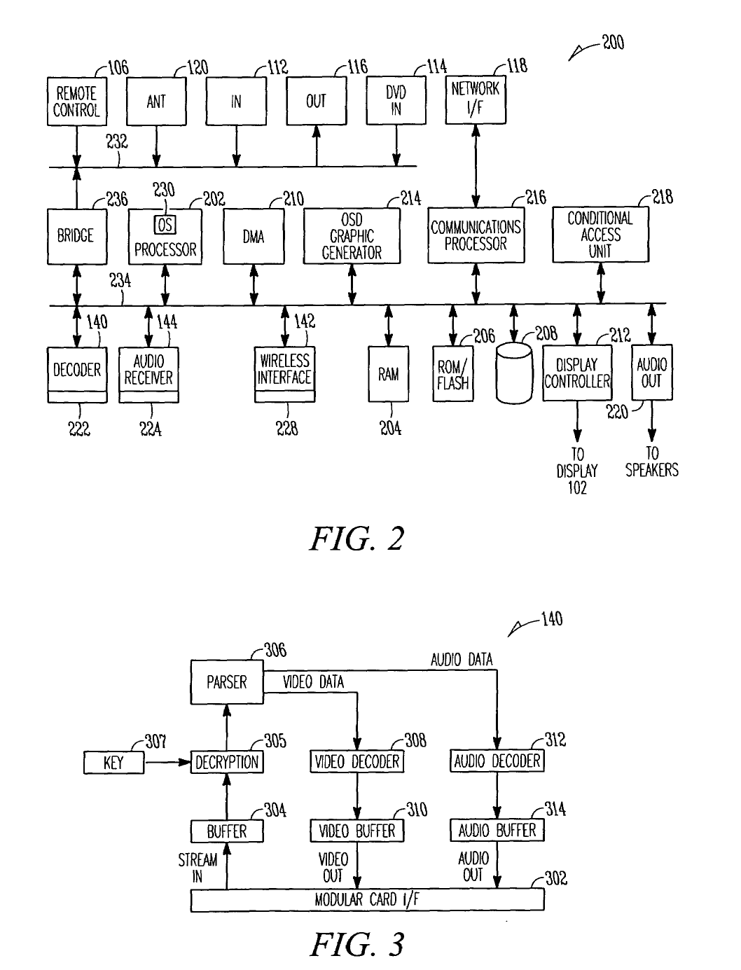

Referring to FIG. 2, an example embodiment of an architecture 200 of the television 100 is illustrated in accordance with at least one embodiment of the present disclosure. The television 100 includes one or more processors 202 (which in an embodiment may be referred to as television-based processors), one or more storage devices, such as a random access memory (RAM) 204, a read only memory (ROM) or flash memory 206 or a hard disk 208, a direct memory access controller (DMA) 210 and a display controller 212 coupled to the display 102 (FIG. 1). The television 100 also can include an overlay graphics generator 214, a network communications processor 216 connected to the network interface 118, a conditional access unit 218, and an audio output 220. The television 100 further can include modular card receptacles 222, 224, and 228 connected to the multimedia decoder modular card 140, the audio receiver modular card 144, and the wireless network interface modular card 142, respectively. As depicted in FIG. 2, the television 100 can further include the remote control interface 106, the RF antenna interface 120, the IN component 112, the OUT component 116, and the DVD IN component 114 of the panel 110 (FIG. 1). In the illustrated example, some components of the television 100 can be connected to a first bus 232 while other components can be connected via a second bus 234. Further, the busses 232, 234 can be connected by a bridge bus 236.

During operation, the various components of the television 100 communicate information via the busses 232, 234 in order to perform various multimedia related functions. For example, the communications processor 216 provides communications protocol specific processing for data received via the network interface 118 and for data to be transmitted on a packet based network via the network interface 118. Further, the communications processor 216 may implement one or more functions associated with, the Open Systems Interconnection (OSI) seven layer model or the Telecommunications Protocol/Internet Protocol (TCP/IP) stack. During operation, incoming data that is processed by the communications processor 216 can be routed to one or more of the components of the television 100 as appropriate. The DMA controller 210 can control access to the RAM 204 and/or the ROM 206 by the components of the television 100. Moreover, the overlay graphics generator 214 can generate overlay graphics that overlay the display graphics that are output to the display 102 by the display controller 212.

In a particular embodiment, the modular cards 140-144 may communicate information with each other and with other components of the television, for example, the processor 202 or the display controller 212, using the modular card receptacles 222-228 and the bus 234. For example, the wireless network interface modular card 142 or the network interface 118 may be used to receive/transmit audio data for the audio receiver modular card 144. Alternatively, multimedia data may be received via one or more of the RF antenna interface 120, the IN component 112, of the DVD IN component 114. Further, video data that represents video content may be provided from the decoder modular card 140 to the display controller 212 so that the video content is displayed by the display 102. Similarly, audio data representing audio content may be provided from the audio receiver modular card 144 to the audio output 220 for output of the audio content by one or more speakers of the television 100.

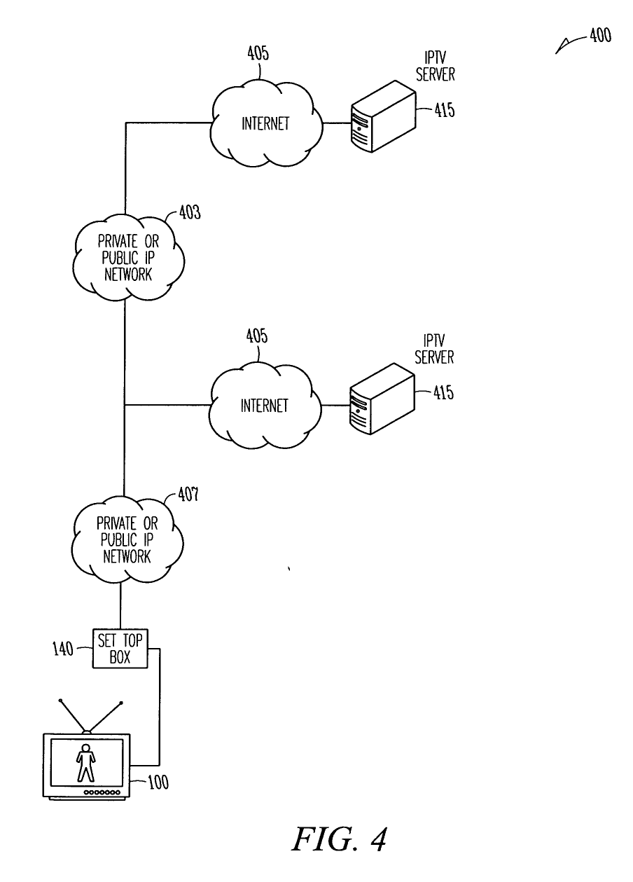

Referring to FIG. 3, an example embodiment of the multimedia decoder modular card 140 is illustrated in accordance with at least one embodiment of the present disclosure. The multimedia decoder modular card may also be referred to as a Set Top Box (STB). In the example depicted, the multimedia decoder modular card 140 includes a modular card receptacle interface 302, an input buffer 304, a decryption module 305, a parser 306, a video decoder 308, a video output buffer 310, and an audio decoder 312 and an audio output buffer 314. In a particular embodiment, the incoming buffer 304 and the output buffers 310 and 314 may be implemented together as a single buffer.

During operation, incoming multimedia data that is to be processed by the decoder modular card 140 is buffered in the incoming buffer 304. In at least one embodiment, the multimedia data is part of an MPEG data stream. Accordingly, the parser 306 parses the multimedia data to identify the relevant video and/or audio data to be processed. Then, the parser 306 provides the video data to the video decoder 308. The video decoder 308 decodes, or transcodes, the video data and the resulting decoded/transcoded data can be stored in the outgoing video buffer 310 before being provided to the bus 234 (FIG. 2) for transmission to one or more components of the television 100. Similarly, the audio decoder 312 decodes or transcodes the audio data. Audio data is decoded/transcoded by the audio decoder 312 and the resulting decoded/transcoded audio data is buffered in the outgoing audio buffer 314 before being provided to the bus 234 for transmission to one or more other components of the television 100.

Alternatively, in one embodiment, the received multimedia data includes non-coded multimedia data. In this instance, the video decoder 308 also may provide a video encoder to encode the video data to generate encoded video data, for example MPEG data, and the audio decoder 312 may include an audio encoder to encode the audio data to generate encoded audio data.

In at least one embodiment, the received multimedia data is encrypted or otherwise protected to prevent unauthorized access to the multimedia content. Accordingly, in at least one embodiment, the integrated decoder modular card 140 further comprises a decryption module 305 to process the protected multimedia data to generate unprotected multimedia data using a decryption key 307 supplied by, for example, a provider of the protected multimedia data. In one embodiment, the decryption module 305 processes the protected multimedia data before it is provided to the parser 306. Alternatively, the decryption module 305 could be implemented at the output of the parser 306 or as part of the decoders 308 and 312.

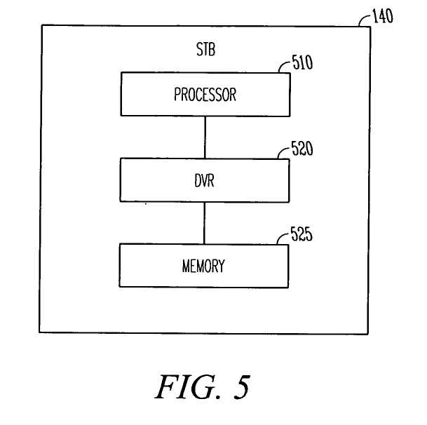

FIG. 4 illustrates an example of the connection of a television 100 such as the one illustrated in FIGS. 1, 2, and 3, or other multimedia processing device, to a network. Referring to FIG. 4, a system 400 includes a television 100, a set top box (STB; or set top card) 140, and one or more public or private networks 403 and 407. The system 400 may also include the Internet 405. Coupled to one of the networks in FIG. 4, for example the Internet 405, is an IPTV server 415.

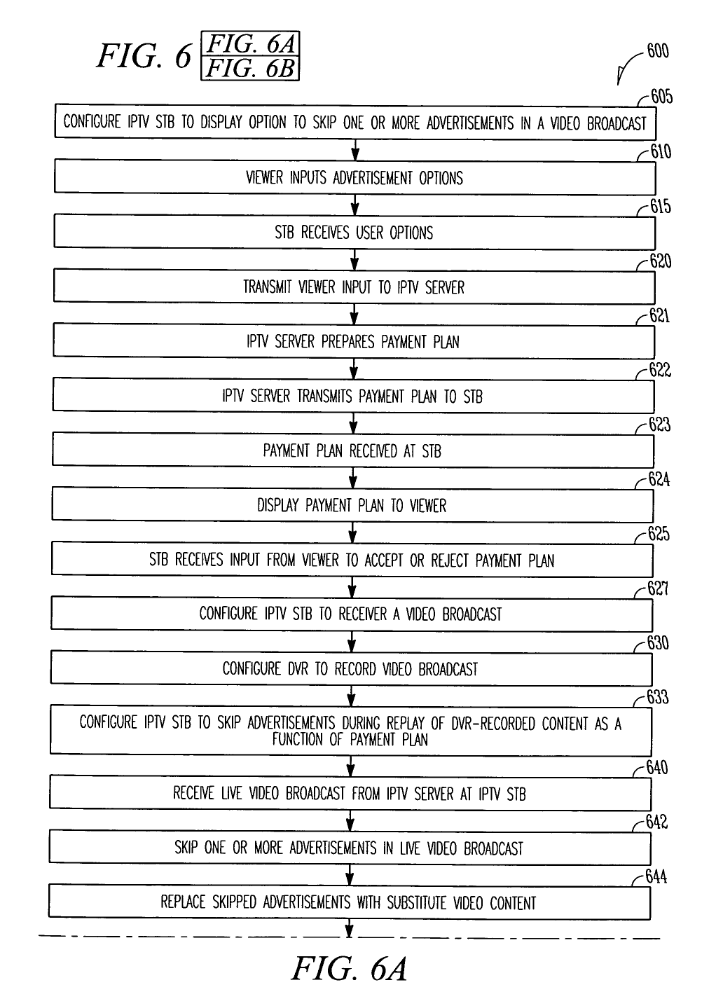

FIG. 5 illustrates an example embodiment of a Set Top Box (STB) 140 that may be used in connection with the networked television and multimedia decoder modular card architectures of FIGS. 1, 2, and 3. In particular, FIG. 5 illustrates a STB 140 that can be configured to provide a viewer with one or more options to skip one or more advertisements in a live or recorded video broadcast, and is further configured to implement the actual skipping of the advertisements during the replay of a recorded video broadcast and/or the reception of a live video broadcast. In FIG. 5, the STB 140 includes a processor 510. FIG. 5 further illustrates that the STB 140 includes a digital video recorder (DVR) 520. In another embodiment, the DVR 520 may be a separate external component coupled to the STB 140 via DVD IN receptacle 114. A memory 525 is associated with the DVR 520.

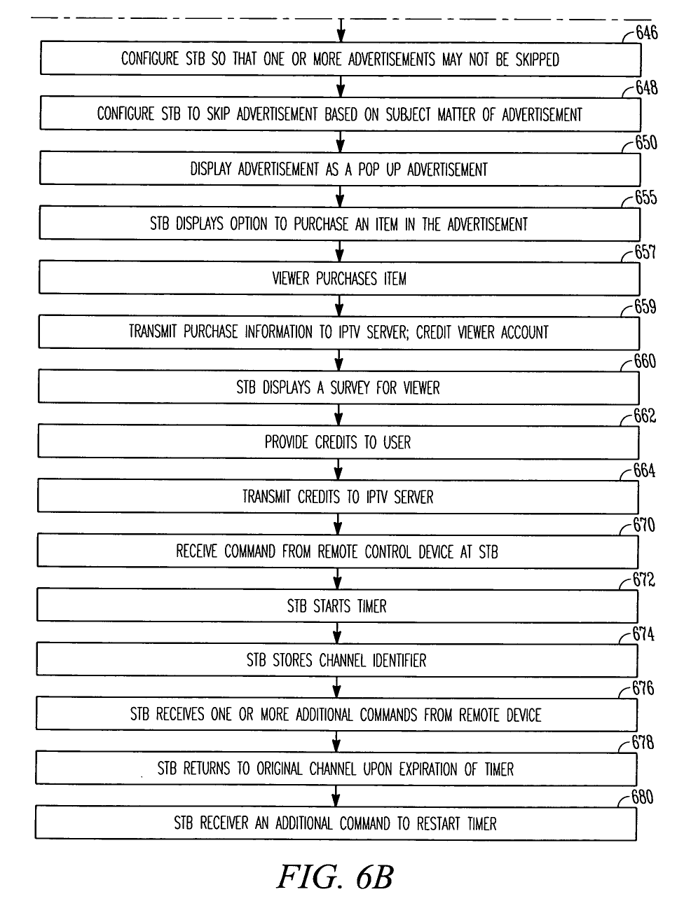

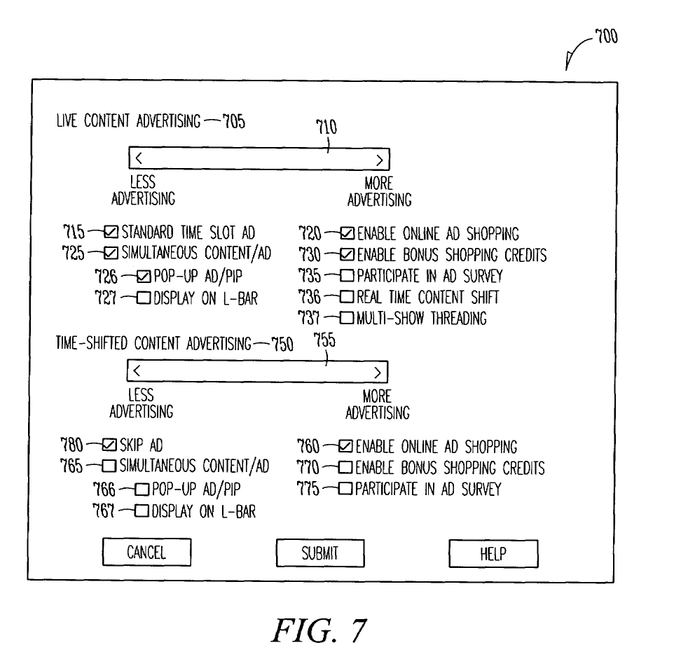

In an embodiment, the STB 140 is configured to first provide an option to a viewer to set up that viewer's television service to skip one or more advertisements during live broadcasts and/or the playback of recorded broadcasts, and second, to actually skip one or more advertisements during the live broadcast and/or the playback of a video broadcast. FIG. 6 illustrates an example embodiment of a process 600 to implement such a feature. At 605, an Internet Protocol Television (IPTV) Set Top Box (STB) is configured to display on a display unit an option to skip one or more advertisements in connection with the programming received in an IPTV video broadcast. This option may be presented in any user interface format, and an example of one such format is illustrated in FIG. 7.

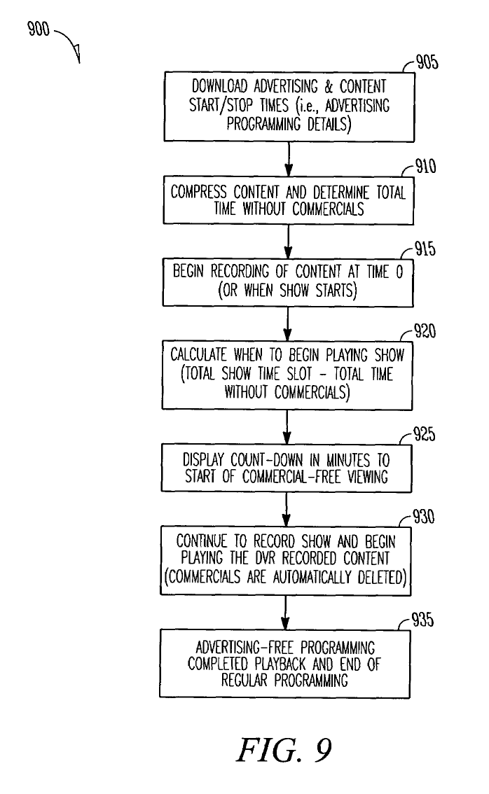

Referring to FIG. 7, a user interface 700 presents several options in connection with the display of advertisements during a live or recorded video broadcast. The interface 700 is divided into a live content advertising section 705 and a time-shifted (e.g., programming recorded via a DVR) section 750. A bar 710 allows a user to tune in the amount of advertising permitted in connection with the viewer's television service. In an embodiment, the more advertising the viewer selects the less the viewer's charge will be for the television service, and vice versa. Below the bar 710 are several additional options that may be selected or deselected via the appropriate checkbox. The Standard Time Slot Ad box 715 allows a subscriber to indicate a block of time in which the selected advertisement options may or may not be effective. The time slot could also be based on a particular viewing event, such as not viewing the advertisements during a sporting event, but rather being provided sports updates during the airing of advertisements. The Enable Online Ad Shopping box 720 provides a viewer with the ability to purchase an item in an advertisement. In an embodiment, the viewer receives a discount from his television service provider for his television service in connection with the purchase. This is enabled via the Enable Bonus Shopping Credits box 730. The Simultaneous Content/Ad checkbox 725 permits the display of pop up advertisements during the broadcast of the program content. Such advertisements may be displayed via a pop up advertisement as indicated in the Pop-Up As/PIP checkbox 726, or on an L-Bar as indicated by the Display on L-Bar checkbox 727. The check box Participate in Ad Survey box 735, if checked, means that a viewer is willing to participate in a survey in connection with the display of an advertisement. In an embodiment, a viewer who participates in such a survey may receive a credit for his or her participation. The Real Time Content Shift checkbox 736 and the Multi-Show Threading checkbox 737 are explained in detail in connection with FIG. 9.

Similarly, the Time Shifted Content Advertising section 750 includes a bar 755 to allow a user to tune in the amount of advertising to be displayed in connection with the viewer's television service, an Enable Online Ad Shopping box 760, a Simultaneous Content/Ad checkbox 765 and its associated checkboxes Pop-Up Ad/PIP box 766 and Display on L-Bar box 767, an Enable Bonus Shopping Credits box 770, and a Participate in Ad Survey box 775. The Skip Ad box 780 allows a user to skip all advertisements.

Returning to FIG. 6, at 610, the viewer enters into the STB the advertisement options that he would like in connection with his television service. This entry of options may be done via the user interface 700 as just described, via a remote device such as the remote device 108, or some other means known to those of skill in the art. The STB receives those options at 615, and at 620 transmits the input received from the viewer to the IPTV server 415. The IPTV server prepares a payment plan at 621 for the IPTV service based on the options selected by the viewer, transmits that payment plan to the viewer at 622, and that plan is received at the STB at 623. In an embodiment, the cost of the viewer's television service is inversely related to the amount of advertisements that the viewer is willing to view as part of his television service. The payment plan is displayed to the user at 624, and the STB receives input from the viewer as to whether the viewer accepts the plan or rejects the plan at 625.

At 627, the IPTV STB is configured to receive a video broadcast from the IPTV service provider. The video broadcast can include one or more advertisements. At 630, the DVR 520 is configured to store the video broadcast in a memory 525. At 633, the IPTV STB 140 is configured to skip one or more advertisements during a playback of the video broadcast as a function of the payment plan. In an embodiment, the advertisements are marked with a flag or other indication, and the DVR 520/STB 140 is programmed by the IPTV service provider, based on the viewer's payment plan, to skip one or more advertisements when the video stored in memory 525 is played back on display unit 101.

In another embodiment, the IPTV STB 140 is configured to skip advertisements in a live video broadcast. In such an embodiment, the IPTV receives a live video broadcast from an IPTV server at 640. The advertisements in the live video broadcast are marked, and depending on the payment plan selected by the viewer, one or more of those advertisements are skipped at 642. At 644, the skipped advertisements are replaced with substitute video content such as comedy clips, weather reporting, news clips, etc. In an embodiment, the substitute video content may be different for each viewer, since each viewer may choose a different option for skipping advertisements. This can be handled by logic at the IPTV server such that the IPTV server will transmit different substitute video content to different viewers (i.e., different STBs). In another embodiment, subscribers can be grouped together vis-a-vis the options that they selected. For example, all subscribers who agreed to view 50% of the advertisements would all receive the same advertisements and also receive the same substitute video content to replace the skipped advertisements. In a related embodiment, the 50% group of viewers may not receive the same substitute video content, but the individual substitute content that they receive would be the same length or duration so as to fit into the slot vacated by the skipped advertisements.

At 646, the IPTV STB is configured so that one or more advertisements may not be skipped, irrespective of the option selected by the viewer and the payment plan resulting therefrom. In an embodiment, the owner of the advertisement pays the IPTV service provider a fee for this feature so that its advertisement cannot be skipped. In another embodiment, the advertisement may be that of the IPTV service provider and/or the content provider, such as an advertisement for an upcoming programming event of the IPTV service provider.

At 648, the IPTV STB skips advertisements based on the subject matter of the advertisement. For example, a user may want to skip all beer commercials. As another example, the user may want to skip all advertisements for motion pictures that are playing in theatres, or all motion pictures that are playing in theatres that have an R rating. Such advertisements are tagged with as many flags or other indicators as needed for an IPTV STB to determine whether an advertisement should be skipped by the IPTV STB.

At 650, for a user that selected the Pop Up option in FIG. 7, the IPTV STB 140 displays pop up advertisements during the display of the programming content. Such an option permits a viewer uninterrupted viewing of the program content, and a reduction in the service charge.

At 655, a viewer who has selected the Online Ad Shopping option in FIG. 7 is presented with an option to purchase an item in an advertisement. If the viewer purchases the item at 657, a message is transmitted by the IPTV STB to the IPTV server. At 659, the IPTV server applies credits to the account associated with that IPTV STB, thereby reducing the service charges for the subscriber-user of that IPTV STB.

Similarly, at 660, the STB displays a survey in which the viewer may participate. Credits are then provided to the user for completing the survey at 662, and the credits are transmitted to the IPTV server at 664 so that the IPTV server may apply the credits to reduce the cost of the IPTV service associated with the IPTV STB.

At 670, the STB receives a command from a remote control device, such as the remote control 108 in FIG. 1. The command causes the STB to start a timer at 672 in connection with the start of an advertisement on the channel that is presently being viewed. At 674, the STB stores a channel identifier, such as the channel number, on which the advertisement is being broadcast in a memory. At 676, the STB receives one or more additional commands from the remote device. These additional commands may include commands to change the channel one or more times (i.e., the viewer may channel surf for the duration of the timer). At 678, the STB returns to the channel on which the advertisement was being broadcast when the timer expires. At 680, the IPTV STB receives an additional command to restart the timer when the timer expires.

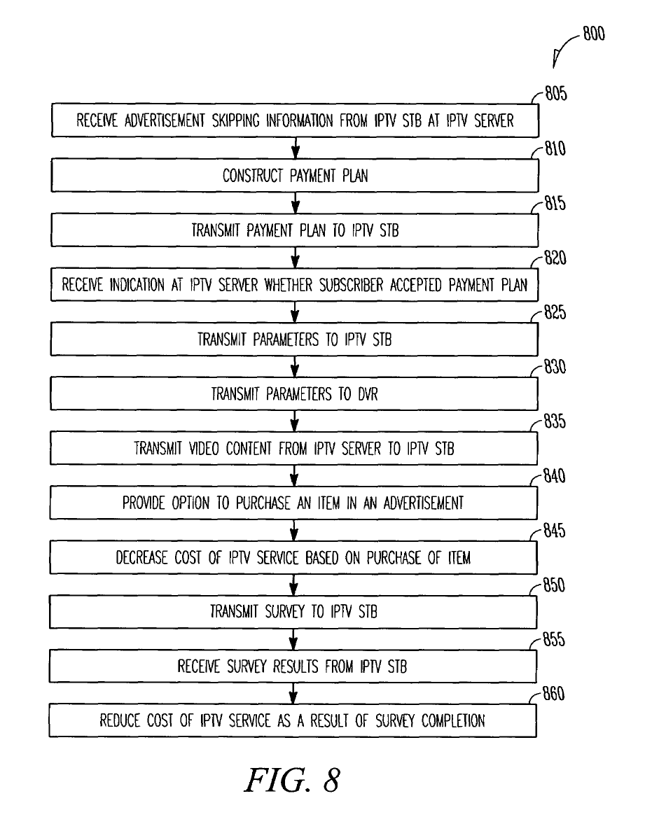

FIG. 8 illustrates an example embodiment of a process 800 to configure an IPTV server in connection with a system and method to skip one or more advertisements in a video broadcast. At 805, information relating to an option to skip one or more advertisements in a video broadcast is received from an IPTV STB at an IPTV server. At 810, the IPTV server constructs a payment plan for the IPTV STB from which it received the information. The payment plan is a function of information relating to the option to skip one or more advertisements. After the construction of the payment plan, at 815, the payment plan is transmitted to the IPTV STB. At 820, the IPTV server receives back from the IPTV STB an indication of whether the subscriber to the IPTV service accepted or rejected the payment plan.

At 825, the IPTV server transmits parameters to the IPTV STB. These parameters are used by the IPTV STB to skip one or more advertisements in a video broadcast. At 830, the parameters are transmitted to a digital video recorder (DVR). The DVR is associated with the IPTV STB, and the parameters are used by the DVR to skip one or more advertisements during a playback of a video broadcast by the DVR. At 835, the IPTV server transmits video content to the IPTV STB. This video content is displayed on a display unit by the IPTV STB to replace the advertisement that are skipped during a live video broadcast.

At 840, the IPTV server provides an option to purchase an item in connection with the display of an advertisement. At 845, the IPTV server decreases the cost of the IPTV service associated with the IPTV STB that purchases such an item as a function of that purchase.

At 850, the IPTV server transmits a survey to an IPTV STB. At 855, the IPTV server receives survey results back from the IPTV STB. At 860, the IPTV server reduces the cost of the IPTV service associated with the IPTV STB as a function of the subscriber completing the survey.

It is noted that in the example processes of FIGS. 6 and 8, some or all of the process steps may be associated with a particular IPTV STB or a particular IPTV server. For example, in FIG. 6, an IPTV subscriber may have his service configured to permit purchases of goods in an advertisement, but not have his service configured to allow participation in surveys. Therefore, many different embodiments are illustrated within FIGS. 6 and 8.

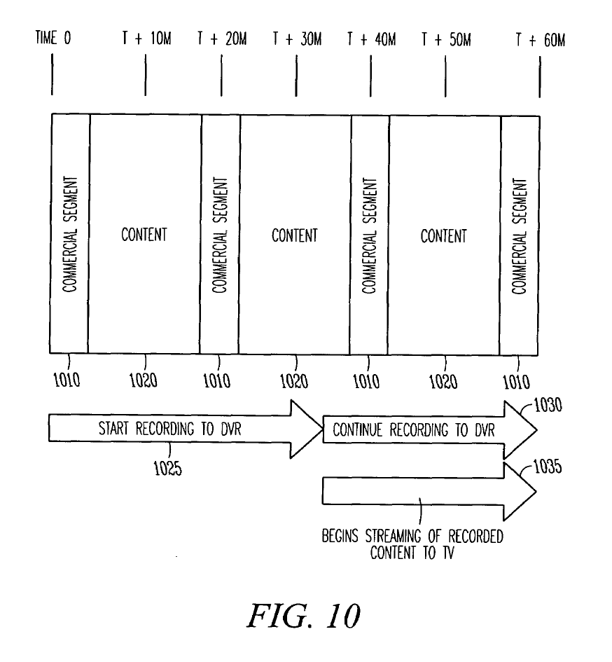

FIG. 9 illustrates another process 900 to skip advertisements during a live video broadcast. If a viewer selects the Real Time Content Shift checkbox 736 in FIG. 7, the IPTV STB receives advertising programming details from an IPTV server at 905. These advertising details contain information on the start and stop times of program content and advertisements within a program segment. A graphic illustration of such a segment is illustrated in FIG. 10, in which commercial segments 1010 are interspersed among program content 1020. At 910, the STB compresses the content, and determines the total time of the program content without any advertisements within the program content. At 915, the IPTV STB begins recording the program content at the time that the show is broadcast. At 920, the IPTV STB calculates the time at which the recorded program content should be replayed. As illustrated at 920, this is calculated by simply subtracting the total time of the program content from the total time allotted to the program content (or show). At 925, the display unit can display a timer to show the time remaining until the start of the replay of the program content from the recorded content. At the expiration of the timer, the IPTV STB begins to play the recorded show, and the DVR continues to record the program content. Consequently, the DVR is recording at the same time that the show is being broadcast. This is illustrated in FIG. 10, where the DVR begins recording program content at 1025, that program content is replayed at 1030, and at the same time, at 1035, the DVR continues to record the program content. As illustrated at 930, the advertisements are automatically removed from the recorded content that is played on the display unit. At 935, the playback of the recorded content ends at the end of the regular time slot for this show. In this manner, a viewer can watch a television show without commercials, and finish watching that show at the end of the time slot for the live video feed of that show. If the subscriber selects the Multi-Show Threading checkbox 737, this time shifting may be done for multiple shows in a consecutive time segment.

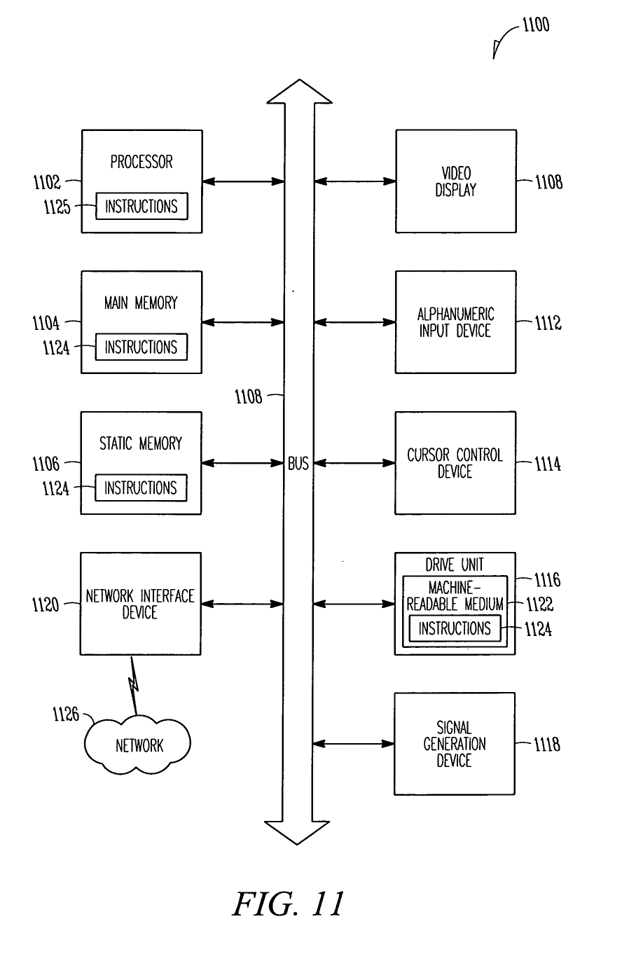

Although the provision of third party video content to subscribers of an IPTV network is described in the context of the networked television 100 and a modular card for ease of illustration, these techniques may be implemented in other multimedia processing devices, such as a set top box, using the guidelines provided herein without departing from the scope of the present disclosure. For example, referring to FIG. 11, an illustrative embodiment of a computer system to implement one or more of the disclosed techniques is shown and designated as 1100. The computer system 1100 may include a set of instructions that can be executed to cause the computer system 1100 to execute any one or more of the methods or computer based functions disclosed herein. The computer system 1100 may operate as a standalone device or may be connected, for example, using a network, to other computer systems or peripheral devices.

The computer system 1100 of FIG. 11, in a networked environment, may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular phone, a web appliance, a network router, switch, or bridge, or any machine capable of executing a set of web instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (for example a central processing unit (CPU), a graphics processing unit (GPU), or both), a main memory 1104 and a static memory 1106, which communicate with each other via a bus 1108. The computer system 1100 may further include a video display unit 1110 (for example a liquid crystal display (LCD) or a cathode ray tube (CRT)). The computer system 1100 also includes an alphanumeric input device 1112 (for example a keyboard), a user interface (UI) navigation device 1114 (for example a mouse), a disk drive unit 1116, a signal generation device 1118 (for example a speaker), and a network interface device 1120.

The disk drive 1116 includes a machine readable medium 1122 on which is stored one or more sets of instructions and data structures (for example, software 1124) embodying or utilized by any one or more of the methodologies or functions described herein. The software 1124 may also reside, completely or at least partially, within the main memory 1104 and/or within the processor 1102 during execution thereof by the computer system 1100, the main memory 1104, and the processor 1102 also constituting machine readable media.

The software 1124 may further be transmitted or received over a network 1126 via the network interface device 1120 utilizing any one or a number of well-known transfer protocols (for example, HTTP).

While the machine readable medium 1122 is shown in an example embodiment to be a single medium, the term “machine readable medium” should be taken to include a single medium or multiple media (for example, a centralized or distributed database, and/or associated caches and servers) that store the one or more sets of instructions. The term “machine readable medium” shall also be taken to include any medium that is capable of storing, encoding, or carrying a set of instructions for execution by the machine and that cause the machine to perform any one or more of the methodologies of the present invention, or that is capable of storing, encoding, or carrying data structures utilized by or associated with such a set of instructions. The term “machine readable medium” shall accordingly be taken to include, but not be limited to, solid state memories, optical and magnetic media, and carrier wave signals.

The above disclosed subject matter is to be considered illustrative and not restrictive, and the appended claims are intended to cover all such modifications, enhancements, and other embodiments, which fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

The abstract is provided to comply with 37 C.F.R. 1.72(b) to allow a reader to quickly ascertain the nature and gist of the technical disclosure. The Abstract is submitted with the understanding that it will not be used to interpret or limit the scope or meaning of the claims.

1. A method comprising:
configuring an Internet Protocol Television (IPTV) Set Top Box (STB) to:
display on a display unit an option to skip one or more advertisements in an IPTV video broadcast;
receive an input relating to the option;
transmit the input relating to the option to an IPTV server;
receive from the IPTV server a payment plan, the payment plan being a function of the input relating to the option; and
receive additional input, the additional input indicating an acceptance or a rejection of the payment plan.

2. The method of claim 1, wherein the payment plan determines the one or more advertisements to be skipped.

3. The method of claim 1, further comprising:
configuring the IPTV STB to receive the video broadcast from an IPTV service provider, the video broadcast including one or more advertisements;
configuring a digital video recorder (DVR) to store the video broadcast in a memory, the DVR and the memory associated with the IPTV STB; and
configuring the IPTV STB to skip one or more advertisements during a playback of the video broadcast as a function of the payment plan.

4. The method of claim 1, further comprising:
configuring the IPTV STB to:
receive a live video broadcast from an IPTV server;
skip one or more advertisements in the live video broadcast as a function of the payment plan; and
replace the one or more skipped advertisements with substitute video data.

5. The method of claim 1, further comprising:
configuring the IPTV STB to:
receive a live video broadcast from an IPTV server;
record the live video broadcast;
calculate a duration of the live video broadcast without the advertisements; and
calculate a time to start the replaying of the recorded video broadcast without the advertisements;
wherein the recording of the live video broadcast and the replaying of the recorded video broadcast occur concurrently; and further
wherein the termination of the replaying of the recorded video broadcast and the termination of the live video broadcast occurs substantially simultaneously.

6. The method of claim 1, further comprising configuring the IPTV STB so that one or more advertisements cannot be skipped; wherein the advertisements that cannot be skipped are a function of a fee paid by an owner of the advertisement.

7. The method of claim 1, further comprising configuring the IPTV STB to display an option in which one or more advertisements are skipped as a function of the subject matter of the advertisement.

8. The method of claim 1, further comprising configuring the IPTV STB to display an option in which one or more advertisements are displayed as a pop up window during the display of the video broadcast.

9. The method of claim 1, further comprising configuring the IPTV STB to:
display an option to purchase an item in connection with the display of an advertisement;
provide credits as a function of the purchased item; and
transmit the credits to the IPTV server so that the IPTV server may apply the credits to reduce the cost of the IPTV service associated with the IPTV STB.

10. The method of claim 1, further comprising configuring the IPTV STB to:
provide an option to participate in a survey, the survey displayed on the display unit by the IPTV STB;
provide credits as a function of the participation in the survey; and
transmit the credits to the IPTV server so that the IPTV server may apply the credits to reduce the cost of the IPTV service associated with the IPTV STB.

11. The method of claim 1, further comprising configuring the IPTV STB to:
receive a command from a remote control device to start a timer in connection with the start of an advertisement;
store a channel identifier on which the advertisement is being broadcast in a memory;
receive one or more additional commands from the remote device, the additional commands including a command to change the channel identifier; and
return to the channel identifier on which the advertisement was being broadcast when the timer expires.

12. A method comprising:
configuring an Internet Protocol Television (IPTV) server to:
receive from an IPTV Set Top Box (STB) information relating to an option to skip one or more advertisements in a video broadcast;
construct a payment plan for the IPTV STB as a function of the information relating to the option to skip one or more advertisements;
transmit the payment plan to the IPTV STB; and
receive from the IPTV STB an indication of an acceptance or a rejection of the plan.

13. The method of claim 12, further comprising configuring the IPTV server to:
transmit parameters to the IPTV STB, the parameters for use by the IPTV STB to skip one or more advertisements in a video broadcast; and
determine substitute video content to be transmitted to the IPTV STB as a function of the advertisements to be skipped in a video broadcast.

14. The method of claim 12, further comprising configuring the IPTV server to transmit parameters to a digital video recorder (DVR), the DVR associated with the IPTV STB, the parameters for use by the DVR to skip one or more advertisements during a playback of a video broadcast by the DVR.

15. The method of claim 12, further comprising configuring the IPTV server to transmit video content to the IPTV STB, the video content to be displayed on a display unit by the IPTV STB when one or more advertisements are skipped during a live video broadcast.

16. The method of claim 12, further comprising configuring the IPTV server to:
provide an option to purchase an item in connection with the display of an advertisement; and
decrease the cost of the IPTV service associated with the IPTV STB as a function of the purchase of the item.

17. The method of claim 12, further comprising configuring the IPTV server to:
transmit a survey to an IPTV STB;
receive survey results back from the IPTV STB; and
reduce the cost of the IPTV service associated with the IPTV STB as a function of the receiving the survey results from the IPTV STB.

18. A Set Top Box (STB) comprising:
a processor; and
a digital video recorder (DVR) coupled to the processor;
wherein the processor is configured to:
display on a display unit an option to skip one or more advertisements in an IPTV video broadcast;
receive an input relating to the option;
transmit the input relating to the option to an IPTV server;
receive from the IPTV server a payment plan; and
receive additional input, the additional input indicating an acceptance or a rejection of the payment plan.

19. The STB of claim 18, wherein the payment play is a function of the input relating to the option.

20. The STB of claim 18, wherein the payment plan determines the one or more advertisements to be skipped.

21. The STB of claim 18, wherein
the processor is configured to receive the video broadcast from an IPTV service provider, the video broadcast including one or more advertisements;
the DVR is configured to store the video broadcast in a memory; and
the processor is configured to skip one or more advertisements during a playback of the video broadcast as a function of the payment plan.

22. The STB of claim 18, wherein the processor is further configured to:
receive a live video broadcast from an IPTV server;
skip one or more advertisements in the live video broadcast as a function of the payment plan; and
replace the one or more skipped advertisements with substitute video data.

23. The STB of claim 18, wherein the processor is further configured to:
receive a command from a remote control device to start a timer in connection with the start of an advertisement;
store a channel identifier on which the advertisement is being broadcast in a memory;
receive one or more additional commands from the remote device, the additional commands including a command to change the channel identifier; and
return to the channel identifier on which the advertisement was being broadcast when the timer expires.
